(19) United States
(12) Patent Application Publication
(10) Pub. No.: US 2010/0041371 A1
(43) Pub. Date: Feb. 18, 2010

(54) SYSTEM AND METHOD FOR MOBILE TELEPHONE-BASED USER AUTHENTICATION

(76) Inventors: Giri Natarajan, La Palma, CA (US); William Su, Riverside, CA (US); Mohammad Suleiman, Trabuco Canyon, CA (US); Tony T. Quach, Anaheim, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/190,245

(22) Filed: Aug. 12, 2008

(51) Int. Cl. H04M 1/66

(52) U.S. Cl. 455/411; 455/406

(57) ABSTRACT

The subject application is directed to a system and method for mobile telephone-based user authentication. Data records are stored in a data storage, with each data record including a cellular telephone number and pre-set payment mechanism data. Login data is received via a user interface associated with a document processing device that includes a telephone number of a cellular telephone associated with the user. The presence of a data record corresponding to the login data is determined, and operation of the document processing device is commenced upon the presence of a data record in the data storage. A data message is sent to the cellular telephone corresponding to the telephone number of the login data. Confirmation data is received from the cellular telephone responsive to the data message, and an operation on the document processing device is completed in accordance with received confirmation data.

### BACKGROUND OF THE INVENTION

The subject application is directed generally to authorization for operation of data devices using a cellular telephone. The application is particularly suited for user authentication and securing payment from operation of devices such as document processing devices. It will be appreciated that the subject cellular telephone-based system and method is readily usable with any device for vending of products or services, particularly those for which a fee is required.

Many devices such as computers, workstations, copiers, printers, facsimile machines, as well as many shared devices including vending or service machines, ATMs, and the like, require users to enter information in order to secure operation. Information, such as user ID and password, serves many different functions. It limits those who are able to use a device, provides a mechanism to track usage, and allows for assessment of fees associated with such use. Users much remember myriad login sequences, not only to use such devices, but also to gain access to databases such as web-based account access, online purchases, and the like. Still other sequences must be recalled to authenticate someone calling into a service that has access to confidential, personal, or financial information of a user.

The many instances where sequences, such as character strings, must be memorized are rendered even more burdensome by the varying requirements for items such as username and password, which are commonly used. Some sites require a minimum number of characters which vary according to a location. Sites also require unique identifiers for each user. Thus, it is difficult for a user to be able to consistently use the same information to gain access in many instances.

### SUMMARY OF THE INVENTION

In accordance with one embodiment of the subject application, there is provided a system and method for mobile telephone-based user authentication. A plurality of data records are stored in a data storage, wherein each data record includes a cellular telephone number and payment data corresponding to a pre-set payment mechanism associated therewith. Login data, comprised of a telephone number of a cellular telephone associated with a user, is received from the user via a user interface associated with a document processing device. The presence of a data record in the data storage corresponding to received login data is determined, and operation of the document processing device is commenced upon a determination of the presence of a data record in the data storage. A data message is sent to the cellular telephone corresponding to the telephone number of the login data. Confirmation data is received from the cellular telephone responsive to the data message, and an operation on the document processing device is completed in accordance with received confirmation data.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a mobile telephone-based user authentication system according to one embodiment of the subject application;

FIG. 2 is a block diagram illustrating device hardware for use in the mobile telephone-based user authentication system according to one embodiment of the subject application;

FIG. 3 is a functional diagram illustrating the device for use in the mobile telephone-based user authentication system according to one embodiment of the subject application;

FIG. 4 is a block diagram illustrating controller hardware for use in the mobile telephone-based user authentication system according to one embodiment of the subject application;

FIG. 5 is a functional diagram illustrating the controller for use in the mobile telephone-based user authentication system according to one embodiment of the subject application;

FIG. 6 is a block diagram illustrating the mobile telephone-based user authentication system according to one embodiment of the subject application;

FIG. 7 is a functional diagram illustrating the mobile telephone-based user authentication system according to one embodiment of the subject application;

FIG. 8 is a flowchart illustrating a mobile telephone-based user authentication method according to one embodiment of the subject application; and

FIG. 9 is a flowchart illustrating a mobile telephone-based user authentication method according to one embodiment of the subject application.

### DETAILED DESCRIPTION OF THE PREFERRED EMBODIMENT

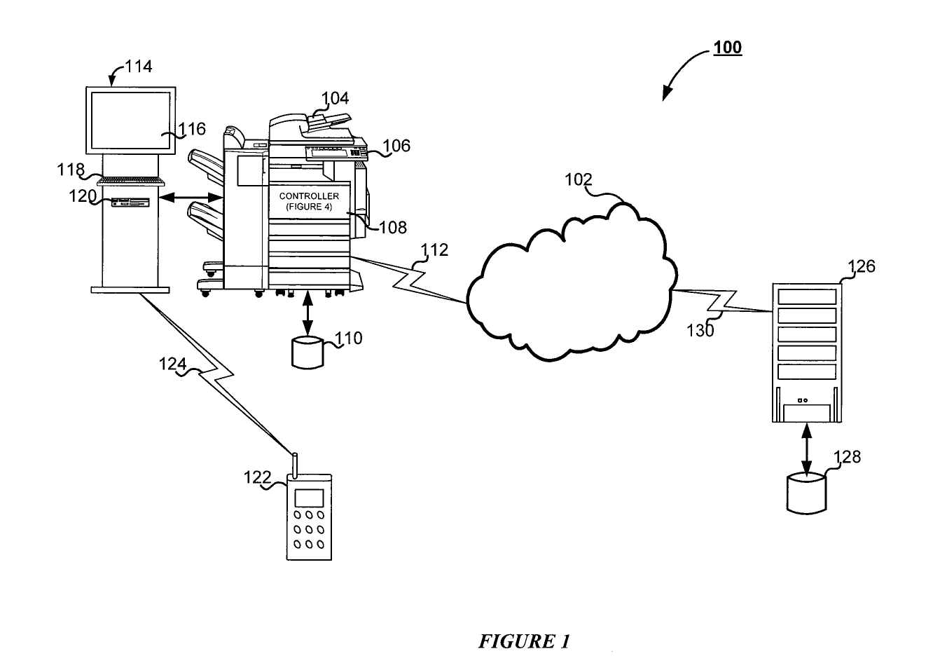

The subject application is directed to a system and method for authorization of operation of data devices using a cellular telephone. In particular, the subject application is directed to a system and method for user authentication and securing payment for operation of devices such as document processing devices. It will become apparent to those skilled in the art that the system and method described herein are suitably adapted to a plurality of varying electronic fields employing user authentication including, for example and without limitation, communications, general computing, data processing, document processing, financial transactions, vending of products or services, and the like. The preferred embodiment, as depicted in FIG. 1, illustrates a document processing field for example purposes only and is not a limitation of the subject application solely to such a field.

Referring now to FIG. 1, there is shown an overall diagram of a system 100 for mobile telephone-based user authentication in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms, such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a document processing device 104, which is depicted in FIG. 1 as a multifunction peripheral device suitably adapted to perform a variety of document processing operations. It will be appreciated by those skilled in the art that such document processing operations include, for example and without limitation, facsimile, scanning, copying, printing, electronic mail, document management, document storage, and the like. Suitable commercially-available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof configured to interact with an associated user, a networked device, or the like.

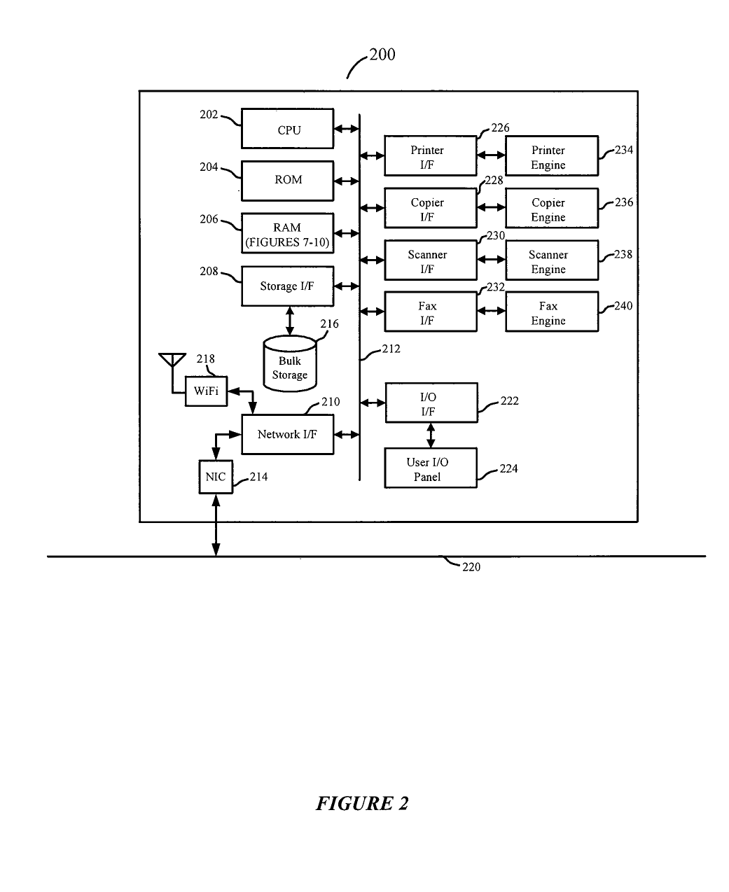

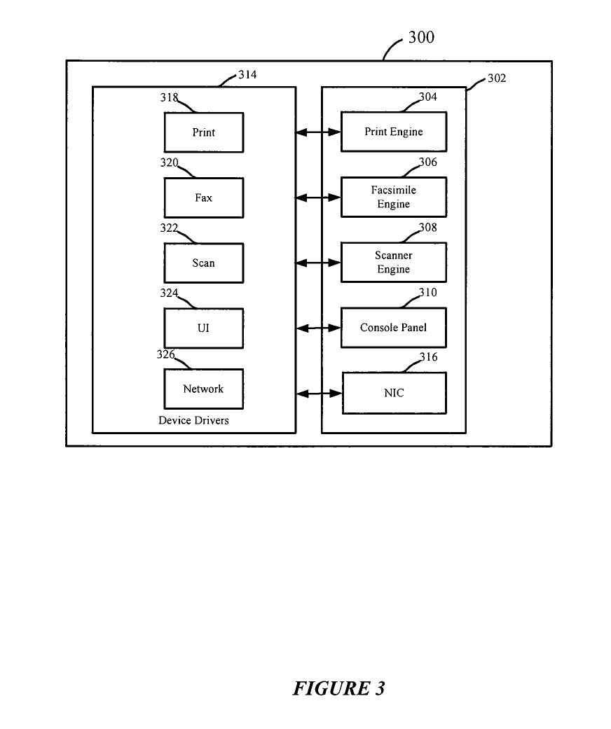

According to one embodiment of the subject application, the document processing device 104 is suitably equipped to receive a plurality of portable storage media including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and to receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user, to receive input from the associated user, and to communicate the same to a backend component such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

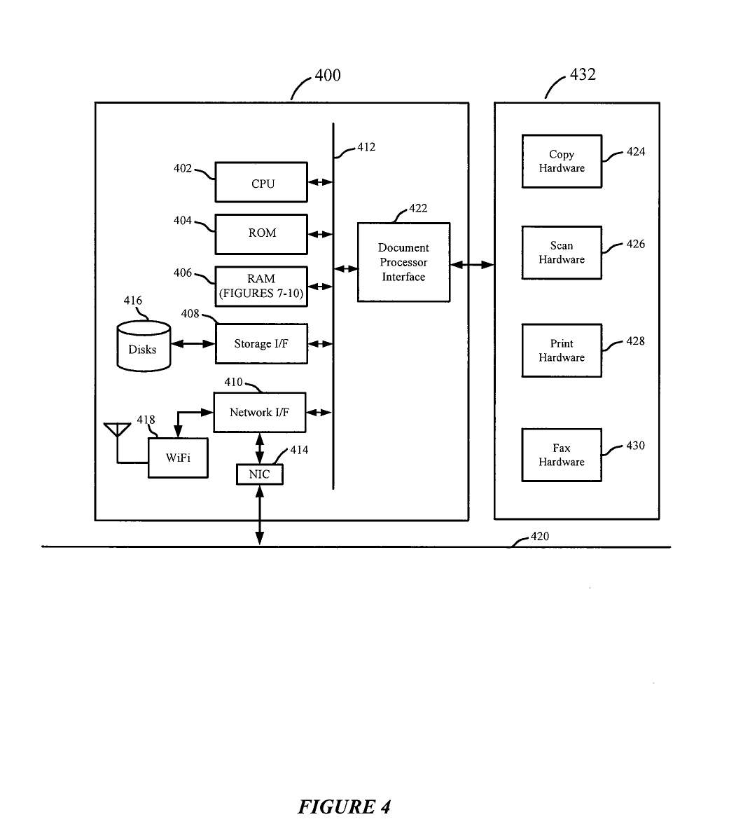

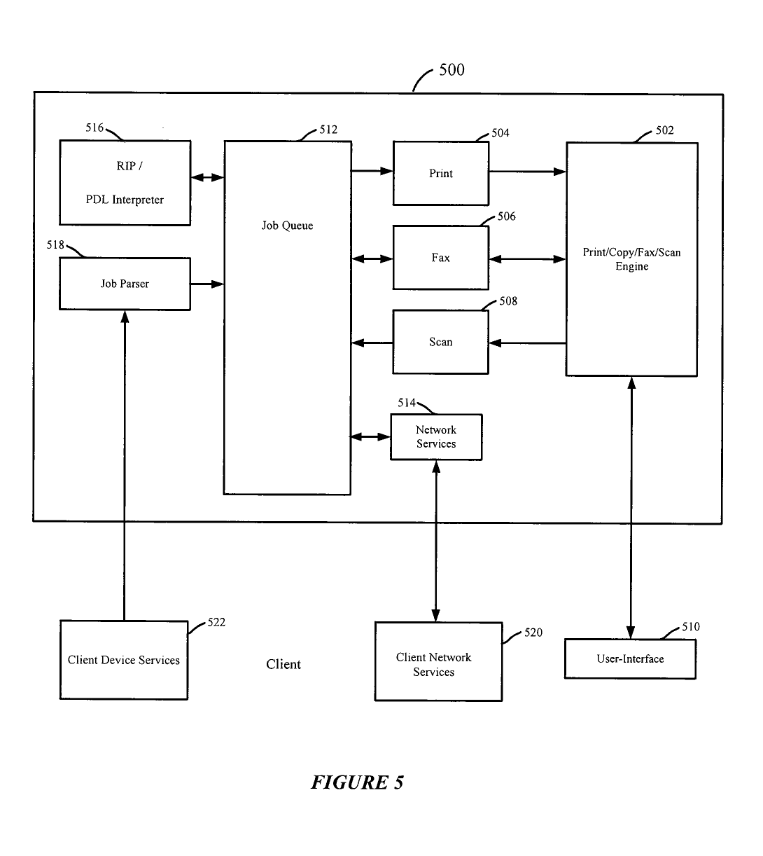

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof configured to control the operations of the associated document processing device 104, facilitate the display of images via the user interface 106, direct the manipulation of electronic image data, and the like. For purposes of explanation, the controller 108 is used to refer to any of the myriad components associated with the document processing device 104 including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for mobile telephone-based user authentication. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In the one embodiment, the data storage device 110 is suitably adapted to store data records, user information, cellular telephone data, pre-set payment data, document data, image data, electronic database data, or the like. It will be appreciated by those skilled in the art that, while illustrated in FIG. 1 as being a separate component of the system 100, the data storage device 110 is capable of being implemented as an internal storage component of the document processing device 104, a component of the controller 108, or the like such as, for example and without limitation, an internal hard disk drive or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like.

Illustrated in FIG. 1 is a kiosk 114, communicatively coupled to the document processing device 104 and, in effect, to the computer network 102. It will be appreciated by those skilled in the art that the kiosk 114 is capable of being implemented as separate component of the document processing device 104 or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes a display 116 and user input device 118. As will be understood by those skilled in the art, the kiosk 114 is capable of implementing a combination user input device/display, such as a touch screen interface. According to one embodiment of the subject application, the kiosk 114 is suitably adapted to display prompts to an associated user, receive document processing instructions from the associated user, receive payment data, receive selection data from the associated user, and the like. Preferably, the kiosk 114 includes a magnetic card reader, conventional bar code reader, or the like suitably adapted to receive and read payment data from a credit card, coupon, debit card, or the like.

The system 100 of FIG. 1 also includes a portable storage device reader 120 coupled to the kiosk 114 and suitably adapted to receive and access myriad different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

The system 100 illustrated in FIG. 1 further depicts a mobile communications device 122 in data communication with the kiosk 114 via a communications link 124. It will be appreciated by those skilled in the art that the mobile communications device 122 is shown in FIG. 1 as a cellular telephone for illustration purposes only. As will be understood by those skilled in the art, the cellular telephone 122 is representative of any mobile personal communications device known in the art including, for example and without limitation, a personal data assistant, a web-enabled cellular telephone, a smart phone, a proprietary network device, or other web-enabled communications device. The communications link 124 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the cellular telephone 122 is suitably adapted to send and receive text messages, to communicate user information and password data, to receive status or job data, or the like with respect to the kiosk 114 or other suitable component associated with the document processing device 104 or with any other similar device coupled to the computer network 102.

The system 100 illustrated in FIG. 1 further depicts a backend component, shown as the server 126, in data communication with the computer network 102 via a communications link 130. It will be appreciated by those skilled in the art that the server 126 is shown in FIG. 1 as a component of the system 100 for example purposes only, and the subject application is capable of implementation via a standalone document processing device 104. The skilled artisan will appreciate that the server 126 comprises hardware, software, or combinations thereof suitably adapted to provide one or more services, web-based applications, storage options, and the like to networked devices. In accordance with one example embodiment of the subject application, the server 126 includes various components implemented as hardware, software, or a combination thereof for managing retention of secured documents and text data, performing searches and comparisons, maintaining data records and account information, receiving payment data, retrieving documents, and the like, which are accessed via the computer network 102. The communications link 130 is any suitable data communications means known in the art including but not limited to wireless communications comprising, for example and without limitation, Bluetooth, WiMax, 802.11a, 802.11b, 802.11g, 802.11(x), a proprietary communications network, infrared, the public switched telephone network, optical, or any suitable wireless data transmission system or wired communications known in the art. It will further be appreciated by those skilled in the art that the components described with respect to the server 126 are capable of implementation on any suitable computing device coupled to the computer network 102, e.g. the controller 108 or the like.

Communicatively coupled to the server 126 is the data storage device 128. According to the foregoing example embodiment, the data storage device 128 is any mass storage device, or plurality of such devices, known in the art including, for example and without limitation, magnetic storage drives, a hard disk drive, optical storage devices, flash memory devices, or any suitable combination thereof. In such an embodiment, the data storage device 128 is suitably adapted to store software updates, secured electronic documents, text data, data strings, account information, policy information, and the like. It will be appreciated by those skilled in the art that, while illustrated in FIG. 1 as being a separate component of the system 100, the data storage device 128 is capable of being implemented as an internal storage component of the server 126 or the like such as, for example and without limitation, an internal hard disk drive or the like.

Turning now to FIG. 2, illustrated is a representative architecture of a suitable device 200, shown in FIG. 1 as the document processing device 104, on which operations of the subject system are completed. Included is a processor 202 suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206 suitably formed of dynamic random access memory, static random access memory, or any other suitable addressable memory system. Random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage such as a disk, optical, tape drive and the like as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, Token-Ring, and the like, and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network subsystem 210 is suitably accomplished via a bus data transfer mechanism, such as illustrated by the bus 212.

Suitable executable instructions on the device 200 facilitate communication with a plurality of external devices such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality, as will be appreciated by one of ordinary skill in the art. The document processing device 300 suitably includes an engine 302, which facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via driver 318, facsimile communication via driver 320, scanning via driver 322, and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that the processor 402 may be advantageously composed of multiple processors working in concert with one another, as will be appreciated by one of ordinary skill in the art. Also included is a non-volatile or read only memory 404, which is advantageously used for static or fixed data or instructions, such as BIOS functions, system functions, system configuration data, and other routines or data used for operation of the controller 400.

Also included in the controller 400 is random access memory 406 suitably formed of dynamic random access memory, static random access memory, or any other suitable addressable and writable memory system. Random access memory 406 provides a storage area for data instructions associated with applications and data handling accomplished by processor 402.

A storage interface 408 suitably provides a mechanism for non-volatile, bulk, or long-term storage of data associated with the controller 400. The storage interface 408 suitably uses bulk storage, such as any suitable addressable or serial storage such as a disk, optical, tape drive, and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, Token-Ring, and the like, and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface card 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4 (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504/506/508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms such as bit map, page description language or vector format, and the like are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

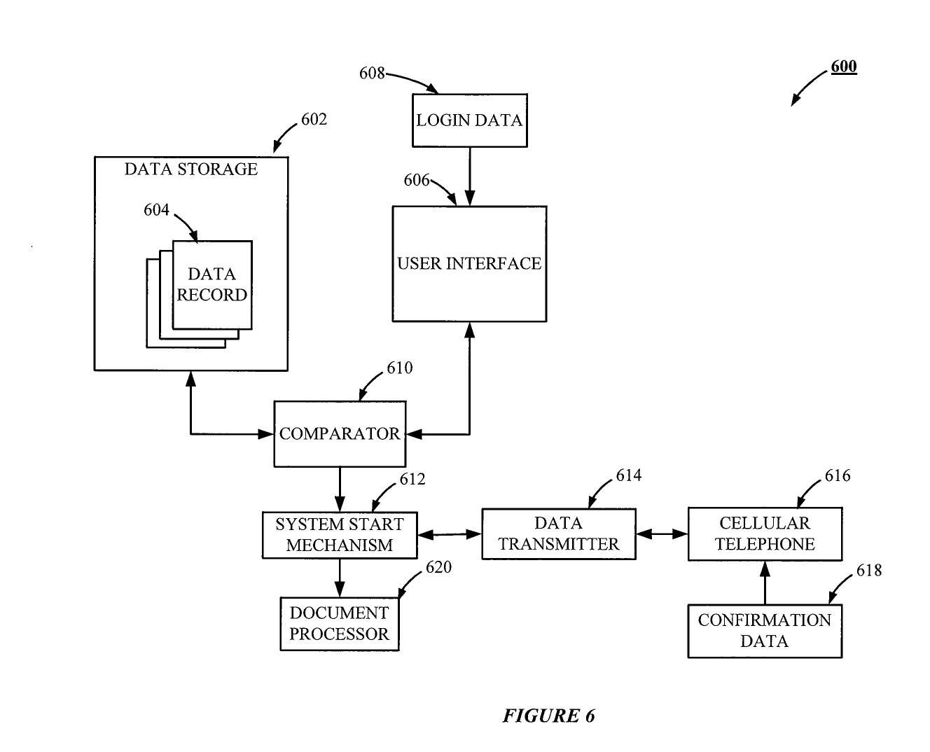

Turning now to FIG. 6, illustrated is a block diagram of a system 600 for mobile telephone-based user authentication in accordance with one embodiment of the subject application. The system 600 includes a data storage 602 containing multiple data records 604, which include a cellular telephone number and payment data corresponding to a pre-set payment mechanism associated with the cellular telephone number. The system 600 also includes a user interface 606, such as the user interface 106 or kiosk 114 associated with the document processing device 104. Login data 608 is then obtained via the user interface 606, comprising a cellular telephone number associated with the user. A comparator 610 then searches the data storage 602 for the presence of a data record 604 corresponding to the login data 608 obtained via the user interface 606. According to one embodiment of the subject application, the comparator 610 searches the data storage 602 for a data record 604 having a cellular telephone number that corresponds to the cellular telephone number associated with the obtained login data 608.

Upon a determination by the comparator 610 that a data record 604 corresponding to the login data 608 is present in the data storage, a system start mechanism 612 is rendered operable by an output of the comparator 610. The system 600 further includes a data transmitter 614 that is operable for data message transmission to the cellular telephone 616 corresponding to the cellular telephone number of the login data 608. Confirmation data 618 is then received from the cellular telephone 616 in response to the data message from the data transmitter 614. The document processor 620 is then operable in accordance with the received confirmation data 618 so as to process the operations of the associated document processing device 104.

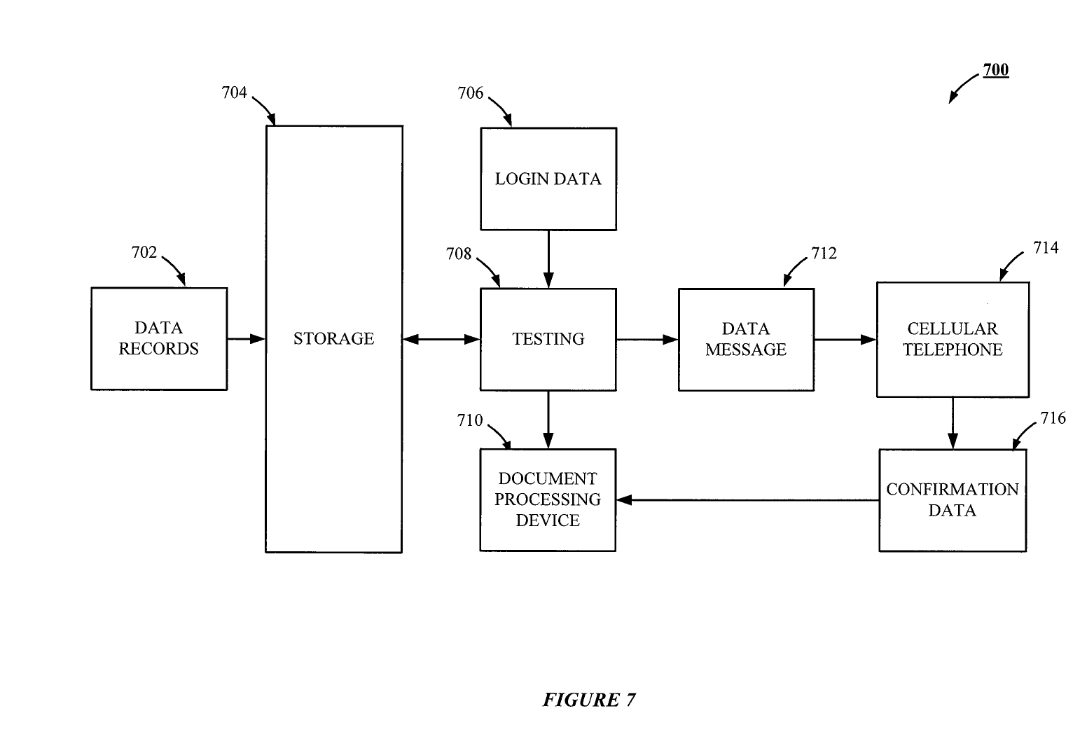

Referring now to FIG. 7, there is shown a functional diagram 700 illustrating the mobile telephone-based user authentication system in accordance with one embodiment of the subject application. A plurality of data records 702 is first stored in an associated data storage 704. Each of the plurality of data records 702 includes a cellular telephone number and payment data corresponding to a pre-set payment method associated with the cellular telephone number. Login data 706 is then received from an associated user via a user interface (illustrated in FIG. 1 as the user interface 106 and/or the kiosk 114) associated with the document processing device 710 (illustrated in FIG. 1 as the document processing device 104). The login data 706 includes, for example and without limitation, a telephone number of a cellular telephone 714 associated with the user. Testing 708 is then performed on the received login data 706 and the data records 702 stored in the storage 704 to determine whether a data record 702 is present in the storage 704 that corresponds to the telephone number received in the login data 706.

Operations of the document processing device 710 are then commenced upon a determination from the testing 708 that a data record 702 is present in the storage 704 that corresponds to the received login data 706. A data message 712 is then communicated to the cellular telephone 714 associated with the telephone number of the login data 706 and corresponding data record 702. Confirmation data 716 is then communicated by the cellular telephone 714 to the document processing device 710, which completes the document processing operation in accordance with the received confirmation data 716.

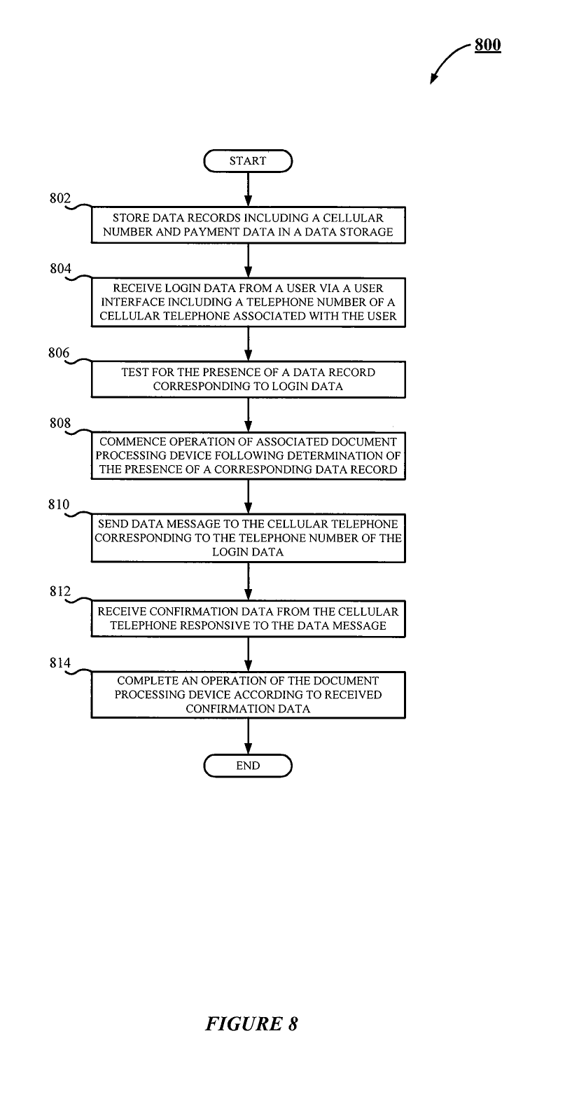

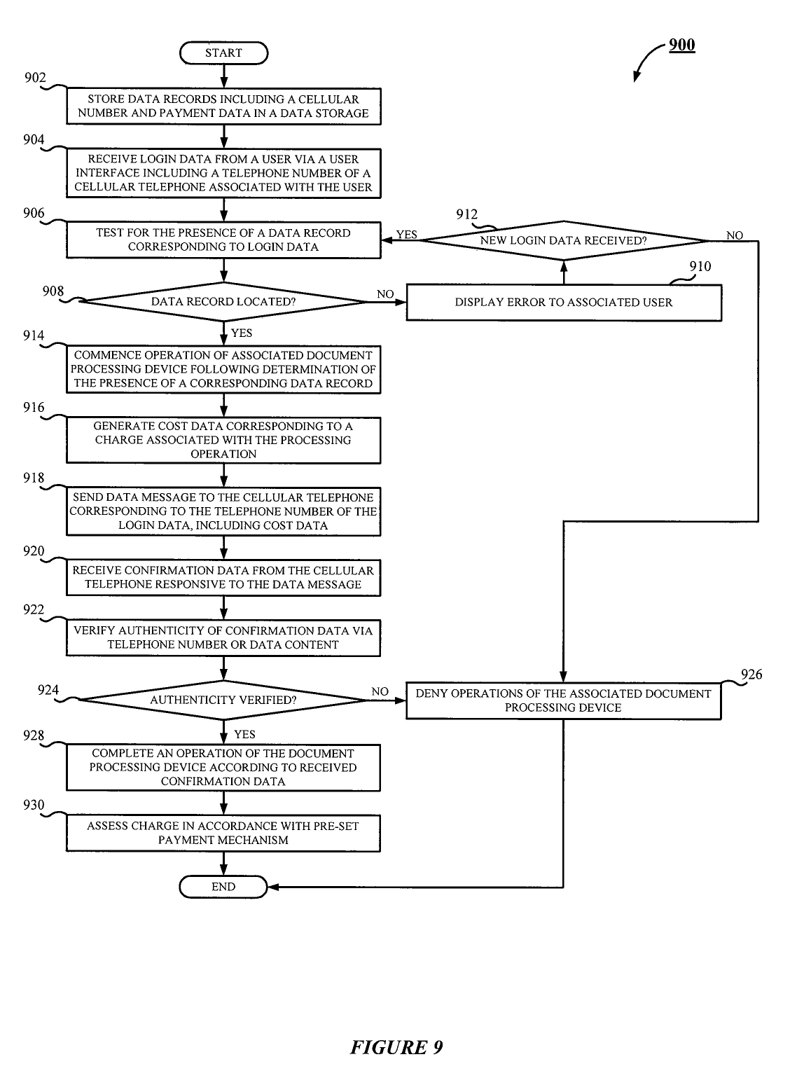

The skilled artisan will appreciate that the subject system 100 and components described above with respect to FIG. 1, FIG. 2, FIG. 3, FIG. 4, FIG. 5, FIG. 6, and FIG. 7 will be better understood in conjunction with the methodologies described hereinafter with respect to FIG. 8 and FIG. 9. Turning now to FIG. 8, there is shown a flowchart 800 illustrating a method for mobile telephone-based user authentication in accordance with one embodiment of the subject application. Beginning at step 802, a plurality of data records is stored in a data storage, e.g. the data storage device 110 associated with the document processing device 104, the data storage device 128 associated with the backend server 126, or the like. Preferably, each of the data records includes a cellular telephone number and payment data corresponding to a pre-set payment mechanism associated with the telephone number.

At step 804, login data is received from an associated user via the user interface 106, the kiosk 114, or the like associated with the document processing device 104. According to one embodiment of the subject application, the login data includes a telephone number of a cellular telephone 122 associated with the user. The controller 108 or other suitable component associated with the document processing device 104, the kiosk 114, or the like then tests for the presence of a data record in the associated data storage 110 corresponding to the login data received from the user at step 806. It will be appreciated by those skilled in the art that such testing is capable of being undertaken by the server 126 with respect to the data storage device 128 in accordance with one embodiment of the subject application when such data records are stored via the computer network 102.

At step 808, operation of the associated document processing device 104 is commenced following a determination from the testing of the presence of a data record in the associated data storage device 110 corresponding to the received login data. A data message is then sent from the controller 108 or other suitable component associated with the document processing device 104 to the cellular telephone 122 corresponding to the telephone number of the login data at step 810. It will be appreciated by those skilled in the art that the communication from the document processing device 104 to the cellular telephone 122 is suitably accomplished via the computer network 102, via a telephone communication with the public switched telephone network, or the like. In accordance with one embodiment of the subject application, the message is an SMS text message, an electronic mail message, or other suitable message format, as will be known in the art.

The controller 108 or other suitable component associated with the document processing device 104 then receives confirmation data from the cellular telephone 122 at step 812 in response to the previously communicated message. The skilled artisan will appreciate that such confirmation includes, for example and without limitation, a reply from the cellular telephone 122 to the received message, a new message to a given telephone number associated with the document processing device 104, an electronic mail message communicated to the document processing device 104, or the like. At step 814, the document processing device 104 then completes the operation in accordance with the received confirmation data.

Referring now to FIG. 9, there is shown a flowchart 900 illustrating a method for mobile telephone-based user authentication in accordance with one embodiment of the subject application. The methodology of FIG. 9 begins at step 902, whereupon multiple data records, each comprising a cellular telephone number and a pre-set payment mechanism, are stored in a data storage such as the data storage device 110, the data storage device 128, or the like. It will be appreciated by those skilled in the art that suitable pre-set payment mechanisms include, for example and without limitation, credit, debit, pre-paid account, billing account, and the like. At step 904, login data is received by the controller 108 or other suitable component associated with the document processing device 104 from a user via the user interface 106, the kiosk 114, or the like. According to one embodiment of the subject application, the login data includes a telephone number of a cellular telephone 122 associated with the user.

At step 906, the controller 108 or other suitable component associated with the document processing device 104 tests for the presence in the data storage 110 or 128 of a data record that contains the same cellular telephone number as that contained in the received login data. It will be appreciated by those skilled in the art that, when the data records are stored on the server 126, the controller 108 or other suitable component associated with the document processing device 104 communicates the received login data to the server 126 for testing thereon. At step 908, a determination is made as to whether a data record has been located in the data storage 110 or 128 containing the same cellular telephone number as that in the login data. In the event that no matching data record has been located, flow proceeds to step 910, whereupon an error is displayed to the user via the user interface 106 or the kiosk 114. A determination is then made at step 912 as to whether the user has provided new login data, e.g. a new cellular telephone number or the like. When no updated login data has been received, operations of the document processing device 104 are denied at step 926 and the flowchart 900 thereafter terminates.

Following a determination at step 908 that a matching data record has been detected, flow proceeds to step 914. At step 914, operation of the document processing device 104 is commenced. That is, the user is able to select a desired document processing operation for performance by the associated document processing device 104. Following such user selection, cost data is generated at step 916 by the controller 108 or other suitable component associated with the document processing device 104 corresponding to a charge associated with the selected document processing operation. A data message is then communicated to the cellular telephone number of the data record, including the generated cost data, at step 918. According to one embodiment of the subject application, the controller 108 or other suitable component associated with the document processing device 104 communicates a text message to the cellular telephone 122 that includes details of the selected document processing operation and the charges associated with the performance thereof.

Confirmation data is then received from the cellular telephone 122 at step 920 in response to the data message. That is, the controller 108 or other suitable component associated with the document processing device 104 receives a reply text message or the like from the cellular telephone 122, indicating a confirmation of the charges. At step 922, the controller 108 or other suitable component associated with the document processing device 104 verifies the authenticity of the received confirmation data via the telephone number or data content of the confirmation data. A determination is then made at step 924 as to whether the received confirmation data has been verified. When no verification has been determined, flow proceeds to step 926, whereupon the user is denied operations of the document processing device 104.

Upon a determination at step 924 that the authenticity of the confirmation data has been verified, flow proceeds to step 928. At step 928, the document processing device 104 completes the selected document processing operation in accordance with the confirmation data received from the cellular telephone 122. At step 930, the controller 108 or other suitable component associated with the document processing device 104, the server 126, or the like thereafter assesses the charge in accordance with the pre-set payment mechanism, e.g. charges the credit card, debit card, pre-paid account, or the like.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications, as are suited to the particular use contemplated. All such modifications and variations are within the scope of the subject application as determined by the appended claims when interpreted in accordance with the breadth to which they are fairly, legally, and equitably entitled.

What is claimed:

1. A mobile telephone-based user authentication system comprising:
a data storage including a plurality of data records, each data record including a cellular telephone number and payment data corresponding to a pre-set payment mechanism associated therewith;
a user interface associated with a document processing device;
login data obtained via the user interface, which login data is comprised of a telephone number of a cellular telephone associated with the user;
a comparator of presence of a data record in the data storage relative to login data;
a system start mechanism for the document processing device operable upon an output of the comparator indicative of presence of a data record in the data storage corresponding to received login data;
a data transmitter operable for data message transmission to the cellular telephone corresponding to the telephone number of the login data;
confirmation data received from the cellular telephone responsive to the data message; and
a document processor operable in accordance with received confirmation data.

2. The system of claim 1, further comprising a cost data generator operable in accordance with a charge associated with the document processing operation.

3. The system of claim 2, further comprising a charge assessor operable in accordance with the pre-set payment mechanism associated with the cellular telephone number.

4. The system of claim 3, further comprising an authenticity verifier relative to received confirmation data operable in accordance with at least one of a telephone number associated with incoming confirmation data and content of incoming confirmation data.

5. The system of claim 4, wherein the data message includes the cost data.

6. The system of claim 5, wherein the pre-set payment mechanism includes at least one of credit, debit, and pre-paid account information.

7. A mobile telephone-based user authentication method, comprising the steps of:
storing, in a data storage, a plurality of data records, each data record including a cellular telephone number and payment data corresponding to a pre-set payment mechanism associated therewith;
receiving from an associated user, via a user interface associated with a document processing device, login data comprised of a telephone number of a cellular telephone associated with the user;
testing for presence of a data record in the data storage corresponding to received login data;
commencing operation of the document processing device upon a determination by the testing step of presence of a data record in the data storage corresponding to received login data;
sending a data message to the cellular telephone corresponding to the telephone number of the login data;
receiving confirmation data from the cellular telephone responsive to the data message; and
completing an operation on the document processing device in accordance with received confirmation data.

8. The method of claim 7, further comprising the step of generating cost data corresponding to a charge associated with the document processing operation.

9. The method of claim 8, further comprising the step of assessing the charge in accordance with the pre-set payment mechanism associated with the cellular telephone number.

10. The method of claim 9, further comprising the step of verifying authenticity of received confirmation data in accordance with at least one of a telephone number associated with incoming confirmation data and content of incoming confirmation data.

11. The method of claim 10, wherein the data message includes the cost data.

12. The method of claim 11, wherein the pre-set payment mechanism includes at least one of credit, debit, and pre-paid account information.

13. A mobile telephone-based user authentication system comprising:
a data storage including means adapted for storing a plurality of data records, each data record including a cellular telephone number and payment data corresponding to a pre-set payment mechanism associated therewith;
a user interface associated with a document processing device;
means adapted for receiving from an associated user, via the user interface, login data comprised of a telephone number of a cellular telephone associated with the user;
testing means adapted for testing for presence of a data record in the data storage corresponding to received login data;
means adapted for commencing operation of the document processing device upon a determination by the testing means of presence of a data record in the data storage corresponding to received login data;
means adapted for sending a data message to the cellular telephone corresponding to the telephone number of the login data;
means adapted for receiving confirmation data from the cellular telephone responsive to the data message; and
means adapted for completing an operation on the document processing device in accordance with received confirmation data.

14. The system of claim 13, further comprising means adapted for generating cost data corresponding to a charge associated with the document processing operation.

15. The system of claim 14, further comprising means adapted for assessing the charge in accordance with the pre-set payment mechanism associated with the cellular telephone number.

16. The system of claim 15, further comprising means adapted for verifying authenticity of received confirmation data in accordance with at least one of a telephone number associated with incoming confirmation data and content of incoming confirmation data.

17. The system of claim 16, wherein the data message includes the cost data.

18. The system of claim 17, wherein the pre-set payment mechanism includes at least one of credit, debit, and pre-paid account information.
